(19) United States
(12) Patent Application Publication
(10) Pub. No.: US 2006/0015841 A1
(43) Pub. Date: Jan. 19, 2006

(54) Control on demand data center service configurations

(75) Inventors: Ellis Edward Bishop, Austin, TX (US); Randy Scott Johnson, Ofallon, MO (US); Tedrick Neal Northway, Wood River, IL (US); H. William Rinckel, Prospect, CT (US); Matthew David Shaw, Firestone, CO (US); Clea Anne Zolotow, Golden, CO (US)

Correspondence Address: IBM CORP. (WIP);c/o WALDER INTELLECTUAL PROPERTY LAW, P.C., P.O. BOX 832745, RICHARDSON, TX, 75083, US

(73) Assignee: International Business Machines Corporation, Armonk, NY (US)

(21) Appl. No.: 10/880,863

(22) Filed: Jun. 30, 2004

(51) Int. Cl. G06F 9/44

(52) U.S. Cl. 717/102

(57) ABSTRACT

An example of a solution provided here comprises: providing a shared platform that is prepared to accept an incoming customer; for the incoming customer (a) planning a configuration of hardware, software, and network components; (b) designing the configuration; and (c) utilizing at least one configuration management control point; accepting the incoming customer, among multiple customers, on the shared platform; sharing hardware and software, among the multiple customers; and maintaining information concerning the shared platform.

### CROSS-REFERENCES TO RELATED APPLICATIONS, AND COPYRIGHT NOTICE

The present patent application is related to a co-pending application entitled On Demand Data Center Service End-to-End Service Provisioning and Management, filed on even date herewith. This co-pending patent application is assigned to the assignee of the present application, and herein incorporated by reference. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to multiple computers or processes, and more particularly to methods and systems of managing shared computing resources.

### BACKGROUND OF THE INVENTION

Customers desire applications that are less expensive to use. A customer's computing cost may be lowered by utilizing a shared platform, utilizing shared services, and by utilizing a large proportion of available computing resources (preferably one fully utilizes the hardware, for example). A shared platform needs to be configured properly. Conventional configuration approaches are not adequate to configure a shared platform, so that it can accommodate the growing business of a customer, and preferably accommodate additional incoming customers, while achieving a high degree of resource utilization.

Thus there is a need for systems and methods of configuration management and shared computing resources, to meet challenges that are not adequately met by conventional configuration approaches.

### SUMMARY OF THE INVENTION

An example of a solution to problems mentioned above comprises: providing a shared platform that is prepared to accept an incoming customer; for the incoming customer (a) planning a configuration of hardware, software, and network components; (b) designing the configuration; and (c) utilizing at least one configuration management control point; accepting the incoming customer, among multiple customers, on the shared platform; sharing hardware and software, among the multiple customers; and maintaining information concerning the shared platform.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a block diagram illustrating an example of a shared platform.

FIG. 3 is a high-level flow chart, illustrating an example of a method of configuration management.

FIG. 4 is a flow chart, giving an overview of an example of a method of configuration management.

FIGS. 5A and 5B together form a flow chart, illustrating an example of a subprocess to validate configuration information for operational components.

FIGS. 6A and 6B together form a flow chart, illustrating an example of a subprocess, to handle a new configuration request.

FIGS. 7A, 7B, and 7C together form a flow chart, illustrating an example of a subprocess to design a configuration.

FIG. 8 illustrates an example of a subprocess to plan configuration implementation.

### DETAILED DESCRIPTION

The examples that follow involve the use of one or more computers and may involve the use of one or more communications networks. The present invention is not limited as to the type of computer on which it runs, and not limited as to the type of network used.

The following are definitions of terms used in the description of the present invention and in the claims:
“About,” with respect to numbers, includes variation due to measurement method, human error, statistical variance, rounding principles, and significant digits.
“Application” means any specific use for computer technology, or any software that allows a specific use for computer technology.
“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.
“On Demand Data Center Services” (ODCS) refers to applications made accessible via a network, such that the user or application provider pays only for resources it uses, or such that resources can shrink and grow depending on the demands of the application. IBM's On Demand Data Center Services offer customers a usage-based and capacity-on-demand approach for running their applications on standard IBM hardware and software platforms, supported by a standard set of services.
“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

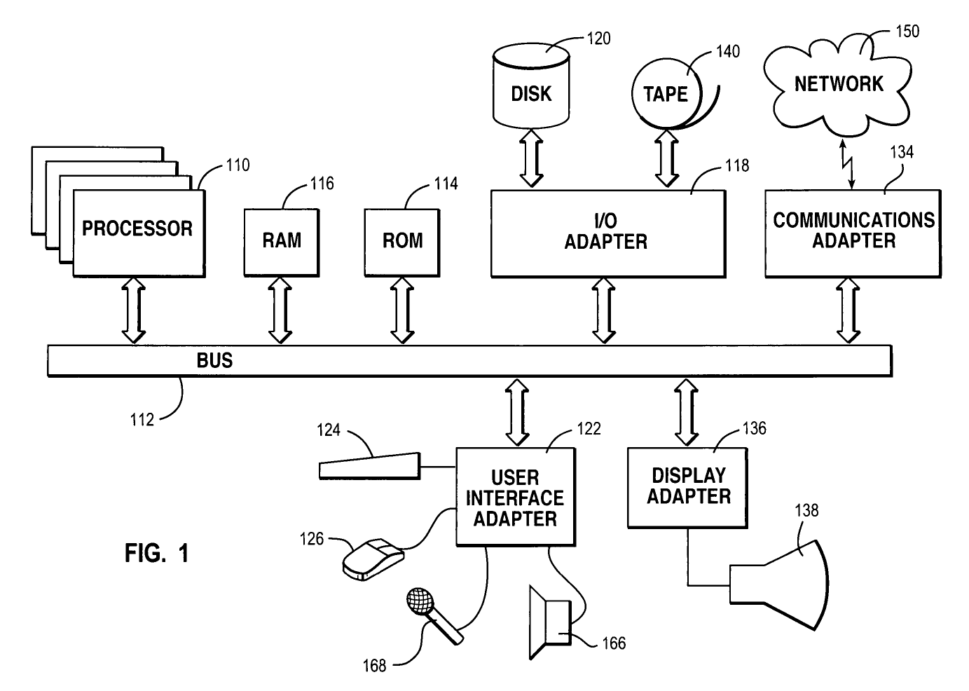

FIG. 1 illustrates a simplified example of an information handling system that may be used to practice the present invention. The invention may be implemented on a variety of hardware platforms, including embedded systems, personal computers, workstations, servers, and mainframes. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a communications network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

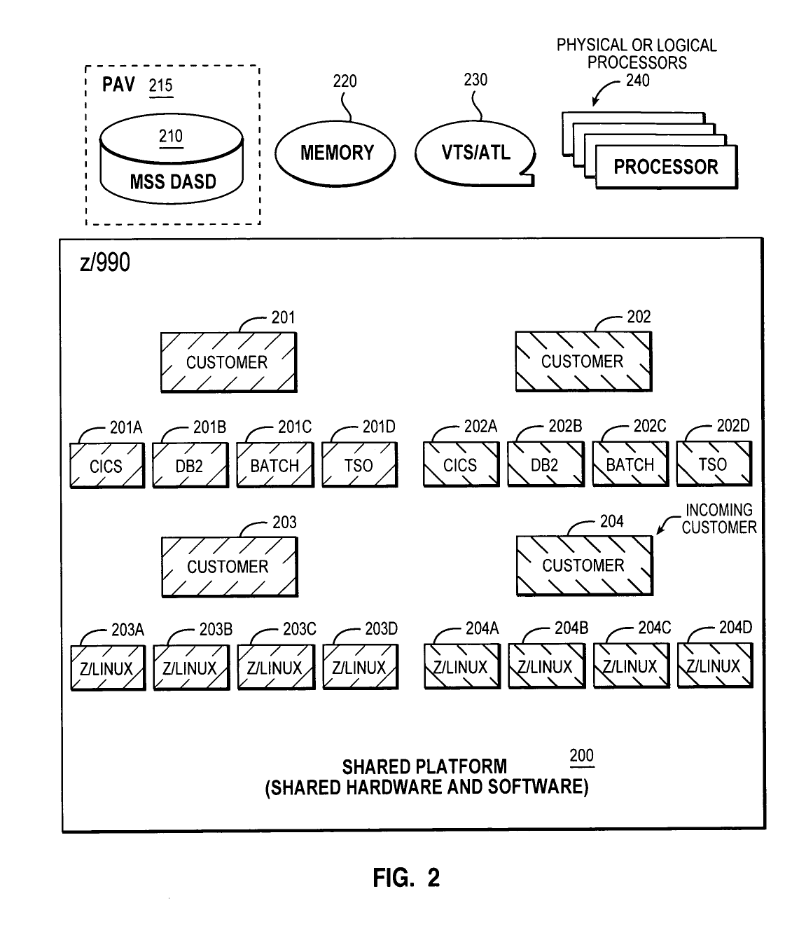

FIG. 2 is a block diagram illustrating an example of a shared platform 200, having a configuration that is defined, tested, approved and documented by the On Demand Data Center Service (ODCS) Configurations methods. Shared platform 200 has one or more parallel access volumes (PAV 215) as an overlay on a real direct access storage device (DASD) 210. Shared platform 200 has memory 220 and virtual tape system or automatic tape library (VTS/ATL) 230. Shared platform 200 has one or more physical or logical processors 240.

FIG. 2 illustrates an example of a method of configuration management, comprising providing a shared platform 200 that is prepared to accept an incoming customer 204.

The following may be performed for the incoming customer 204: planning a configuration of hardware, software, and network components; designing the configuration; building, testing, and implementing the configuration, utilizing at least one configuration management control point. The example involves accepting the incoming customer 204, among multiple customers 201-203, on the shared platform 200. The example involves sharing hardware and software, among the multiple customers 201-203; and maintaining information concerning the shared platform 200.

One of the offerings in the ODCS is to not only have multiple customers 201-204 on their logical partitions (LPAR's) sharing the same hardware, but also to have multiple customers 201-204 sharing the same subsystem within the same logical partition (LPAR). For example in the shared platform 200, there may be one zVM LPAR with multiple customers running on separate zLINUX instances (symbolized by blocks 203A-204D, marked Z/LINUX). “Subsystem” may mean specific software such as software sold under the trademarks CICS, DB2 and WEBSPHERE by IBM (customer information control system or CICS symbolized by blocks 201A and 202A; and DB2 symbolized by blocks 201B and 202B). “Subsystem” may mean specific software running for a particular customer, such as a company's accounting software. Subsystems are symbolized by blocks 201A-202D. The ODCS configuration method involves maintaining information concerning the shared platform 200, where multiple customers 201-204 are running on the same piece of hardware. The hardware and the system software is designed to accept the incoming customer 204. This method also considers transition and the production environment.

FIG. 2 shows an example of a shared environment in the mainframe sold under the trademark z/990 T-REX by IBM, having multiple customers 201-204 running multiple subsystems. Not only does the individual workload, like CICS, need to be taken into account, but also changing the performance parameters on CICS for Customer 201 may affect Customer 202. The configuration analyst deals with shared platform 200 such as FIG. 2, with the possibility of shared channels between the subsystems, that is tracked as part of the configuration.

Planning further comprises performing calculations for one or more capacity planning items chosen from: processors; channel subsystem; memory; storage; and storage area network. For example, processor (CPU) configuration covers operating systems sold under the trademarks z/OS, z/VM, and AIX, by IBM. Each one requires different configurations to be able to accept multiple customers.

z/OS involves LPAR definitions and rolls within a parallel sysplex. LPAR definitions are the layout of the virtual hardware parameters that specify the machine configuration, and the rolls are the backup and data sharing scenarios. For example, LPAR1 is primary, and LPAR2 is the roll LPAR in case LPAR1 goes down. For data sharing, LPAR1 may own the data entry terminals, but the application can run on multiple LPARs if needed (e.g. LPAR1 is 100% busy, then slide over to LPAR2). Parallel Sysplex is an IBM hardware function that connects multiple processors to make one Central Electronic Complex (basically allowing multiple processors to work together as one larger processor).

z/VM operating systems in the ODCS model run z/LINUX. Each individual z/LINUX can belong to a different customer. ODCS designed each individual instance as to not interrupt the other instances. Here are two examples. One is using a CPU governor for z/LINUX that caps the utilization, the second is to use DASD isolation by allocating virtual machine (VM) minidisks to specific z/LINUX instances. The software product sold under the trademark VMWARE is used on the xSeries processor and makes the xSeries look like a z/VM system (the software product sold under the trademark z/VM by IBM) and thereby able to support multiple customers in the same manner as z/VM.

AIX runs for example on a p690 with multiple customers on the same box, each with their own individual LPAR. One may dynamically adjust the customers' CPU utilization across the box, using the new dynamic LPAR in AIX 5.3, where fractional CPU's can be assigned to an LPAR. We can define logical processors (at 240 in FIG. 2) to a customer instead of physical processors. This takes the concepts used in Z/OS and implements them in the pSeries/AIX.

Consider storage and an example involving varying the number of parallel access volumes (PAV, at 215 in FIG. 2) due to a load on the shared platform. A parallel access volume (PAV) is an overlay on a real direct access storage device (DASD 210 in FIG. 2) and is the way that applications access data. The number of PAV's are variable, which create the parallel function (for example, with 2 PAV's, two different applications can access the same data at the same time). Previous S/390 systems allowed only one input/output (I/O) operation per logical volume at a time. Now, performance can be improved by enabling multiple I/O operations from any supported operating system to access the same volume at the same time. With Static PAV the number of PAVs are fixed. Dynamic PAV varies the number of PAVs due to load on the device. As the utilization increases, more PAVs are assigned. However, a Logical Control Unit (LCU) is not shared. If you have 1 LCU behind 8 physical volumes of DASD, you should not assign 4 to one parallel sysplex and 4 to another, because at that point each sysplex does not communicate and will ‘steal’ the dynamic PAVs from the other sysplex. The stealing will degrade performance for the other parallel sysplex as more PAVs are needed than are available.

Concluding the description of FIG. 2, it serves as an example of a system of shared computing resources, comprising: means for sharing hardware and software, among multiple customers 201-203; and means for accepting an incoming customer 204. The incoming customer 204 does not impact another customer's capacity requirements. The system comprises means for allowing each customer to use about 20% or 25% more resources than expected. For example, regarding processors at 240, ODCS planning may place a hard cap on an LPAR at 112 MIPS, which is about 20% more than required plus a performance buffer. See also the description of a CPU governor above. In the X and P series processors, the 20% overage is built into the initial sizing by utilizing a pool of unused engines, for example.

Regarding storage, dynamic PAV's, mentioned above, provide a means for varying the number of parallel access volumes according to load on the platform. As the utilization increases, more PAV's are assigned at 215. Virtual tape system or automatic tape library (VTS/ATL) 230 comprises means for providing each of the multiple customers with a tape containing unique stored data belonging to that customer.

An overall system of shared computing resources may comprise means for maintaining information concerning the shared platform 200. For example, the computer in FIG. 1 may serve as a system management computer linked via network 150, to shared platform 200 in FIG. 2, and maintaining configuration information.

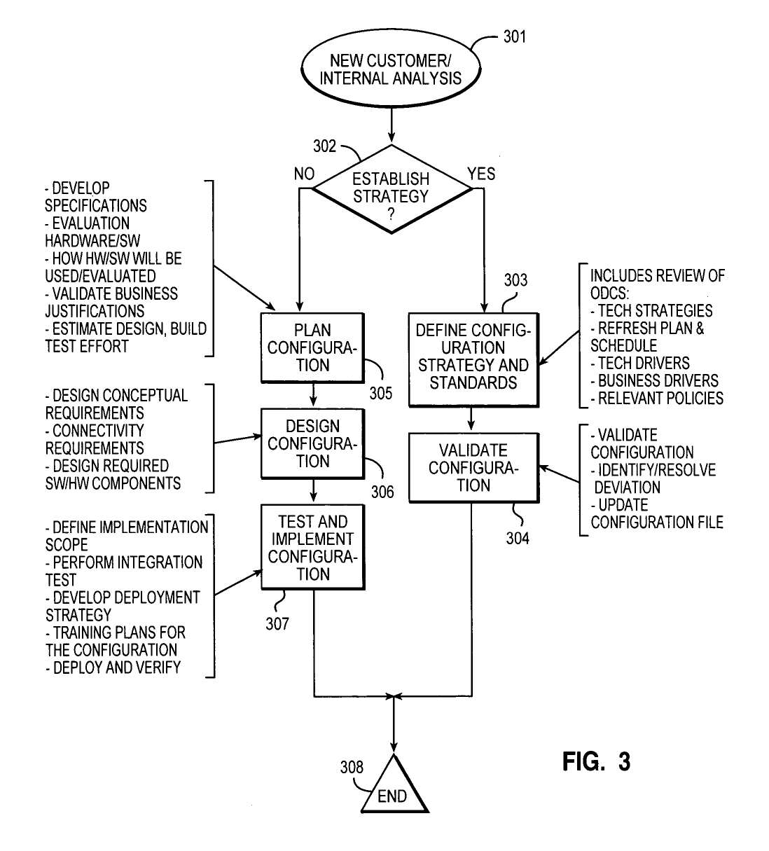

FIG. 3 is a high-level flow chart, illustrating an example of a method of configuration management. The right path is an internal analysis for defining the strategies and standards that will be used to support all customers. The left path sets up a new customer after the strategies and standards have been crafted.

301. New Customer/Internal Analysis. Requests for configuration support may stem from a new customer where resources are allocated and then managed. The other option is an internal analysis for defining the strategies and standards that will be used to support all customers.

302. Establish Strategy? Determine the path of action to be taken. If Yes, proceed to Define Config(uration) Strategy And Standards 303. If No, proceed to Plan Configuration 305.

303. Define Config(uration) Strategy And Standards. This step begins to address the technology strategies to be employed, the Technology Refresh plan and schedule, technology and business drivers for the customer, and relevant policies.

304. Validate Configuration. Once configuration has been defined, the configuration is validated to ensure it meets customer needs. This step resolves issues and updates the necessary files. Process proceeds to End at block 308.

305. Plan Configuration. Note: steps 305-307 are performed to set up a new customer after the Strategies and Standards have been crafted. Planning the configuration includes the development of specifications as required for the environment. Evaluation of the hardware and software and how it will be used. Validation of the configuration against the business requirements and an estimation of the actual design, build and test effort.

As input at block 305, a customer provides all the usage information necessary. Engagement creates a TSD (Technical Solution Document) and provides it to ODCS that has the customer's requirements translated into computing resource requirements. It is used to build out the configuration needed by the customer including processor, memory and disk storage. The TSD is used by the architects to build an initial sizing that gets passed on to capacity planning and the System Administrators for implementation. Capacity Planning reviews the sizing and corrects it if necessary. ODCS contracts allow a customer to exceed the contracted sizing by 20% to allow for growth, for example. In the X and P series processors, the 20% overage is built into the initial sizing by utilizing a pool of unused engines. In the zSeries processor, the architect requests capacity planning to do the sizing, which is augmented by tools such as CP2000 (a capacity planning tool) or z/PCR (Processor Capacity Reference) to ensure LPAR overhead will not degrade the box.

As output at block 305, quantity and type of resources are allocated. Preferably, this standard method is used for all customers, the only difference is the quantity and type of resources allocated (for example, 30 Terabytes, 90 million instructions per second (MIPS), LPAR configuration including weight & capping). For example, consider an LPAR configuration of the z/990 T-REX (see FIG. 2). The weighting is split between the z/OS and z/VM (integrated facility for LINUX, IFL) partitions.

Preferably, the incoming customer's resource requirements are met by fitting the incoming customer within the existing hardware if possible. Preferably one fully utilizes the hardware, but a keen eye is required to determine how to configure the hardware for the best fit. For example on the zSeries processor configuration above, performance reports show that NGZ2 is running at 3% busy. Total processor MIPS=855, 3% busy is 26MIPS (855*.03), leaving 829 MIPS free for allocation. Therefore, ODCS can create an LPAR that requires 90 MIPS in the 2 engines assigned to z/OS in the z990 book (a book is equivalent to 8 engines). 90 MIPS is well below the available 829 MIPS. The workload requires 90 MIPS, therefore ODCS places a hard cap on this LPAR at 112 MIPS, which is about 90+ (90*0.25), or 20% greater than required, plus a performance buffer. If the LPAR had required more than 829 MIPS, another engine would have to be added to the book from the 4 engines in reserve.

At block 305, similar calculations are performed for the remaining four capacity planning items. This includes the channel subsystem, memory, storage, and storage area network.

306: Design Configuration involves designing of the conceptual requirements along with supporting requirements such as connectivity, networking, and the required software and hardware components. The new design cannot impact other customer's capacity requirements. A control point in configurations exists at the design stage. A Control Point is a position in a process at which a major risk exists and the process owner determines that an action or activity must be completed in order to ensure the integrity of the process. The process must adhere to a Corporate Instruction related to configuration management: Manage the physical and logical properties of IT resources and their relationships while ensuring that service commitments and IBM IT standards are achieved. A control point in configurations is at the design stage. On-Demand Data Center Services Architectural Design is a document that is created during the design section of this process, has the standard design described and has been approved by all required levels of management. Any changes to the document will require reapproval. A good measurement for this control point would be the number of changes per year. Depending on the control point, other examples of measurements are items like percent successful (e.g. 98 successful changes out of 100), cycle time (e.g. average turnaround to configuration request of 2.5 days), or labor hours to implement request (e.g. 3.2 hours per request).

307: Test And Implement Configuration. The design has been approved. This stage involves definition of the implementation scope, integration testing, designing and executing the deployment strategy, developing and providing training as required. The customer is boarded onto the configuration. Process proceeds to End.

308. End; Process is complete, no further processing for setup or for this customer or request.

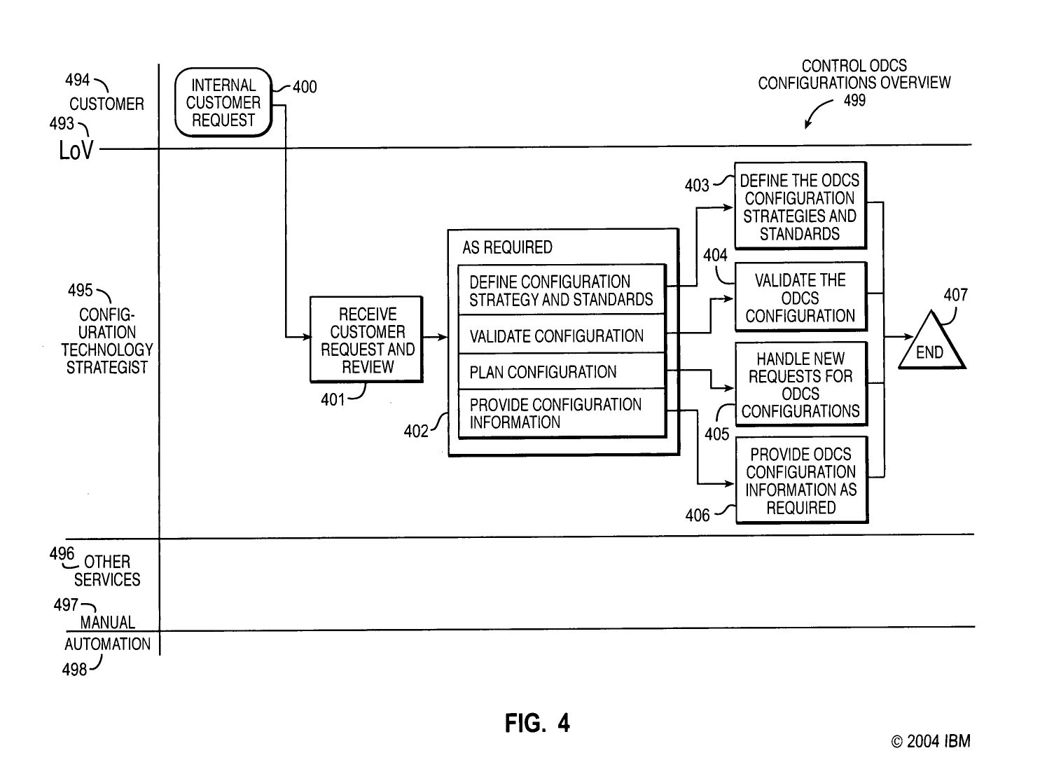

FIG. 4 is a flow chart, giving an overview of an example of a method of configuration management. First, note some common features found in FIGS. 4-8. Header 499 provides a description of this view. FIG. 4 is a control ODCS configurations overview. Labels in the column at the far left identify the role (such as Configuration Technology Strategist 495) or tool that performs activities within its row or lane. The line below Customer Lane 494 is the “Line of Visibility” (LoV). The Customer does not see anything below this line. Flow lines that cross this boundary define interface points with the Customer. In “Other Services” lane 496, processes are provided by an external group or function (external to the ODCS team).

Note Automation lane 498. Activities above Automation lane 498 typically are performed by people, and activities in Automation lane 498 typically are performed by tools, in these examples. Many opportunities for automation exist, but most have been omitted from FIGS. 4-8, to simplify the diagrams.

Beginning with a general view of FIG. 4, the example begins with a customer's request at 400, and receiving a configuration request at block 401. Inputs are details of the configuration request. Outputs include: Configuration strategy and standards defined (from block 403)
Configurations validated (from block 404)
Configurations defined, tested, approved and documented for the software and hardware components required to fulfill the need identified in the configuration request (from block 405)
Configuration information updated (from block 406) Note 406 may serve as a configuration management control point, i.e. a configuration update. This involves an Information Technology Service Management Corporate Instruction, regarding Configuration Update and Assessment—allowing updates to the current configuration and providing configuration specifications to the appropriate IT personnel for review.

Continuing with details of FIG. 4:

401: Receive and Review Request.

402: Choose As Required (multiple-choice box 402). Based on the request or ODCS Configuration Management, options are provided for directing the request to the appropriate subprocess where actual processing of the request is addressed. If Defining Configuration Strategy and Standards, proceed to Define Configuration Strategy and Standards 403. If Validating a Configuration, proceed to Validate Configuration 404. If Developing a New Configuration, proceed to Handle New Configuration Request 405. If Providing Configuration Information, proceed to Provide Configuration Information 406.

403: Define Configuration Strategy and Standards (Subprocess) Invoke the Define Configuration Strategy and Standards subprocess to establish or modify ODCS Configuration Strategy and Standards. Proceed to end.

404: Validate Configuration (Subprocess). Invoke the Validate Configurations subprocess to validate an active configuration against a stored configuration. Proceed to end.

405: Handle New Configuration Request (Subprocess). Invoke the Handle New Configuration Request subprocess to handle the request. Proceed to end.

406: Provide Configuration Information. Provide the requested configuration information to the requester. Proceed to end.

407: End the Control Configurations process.

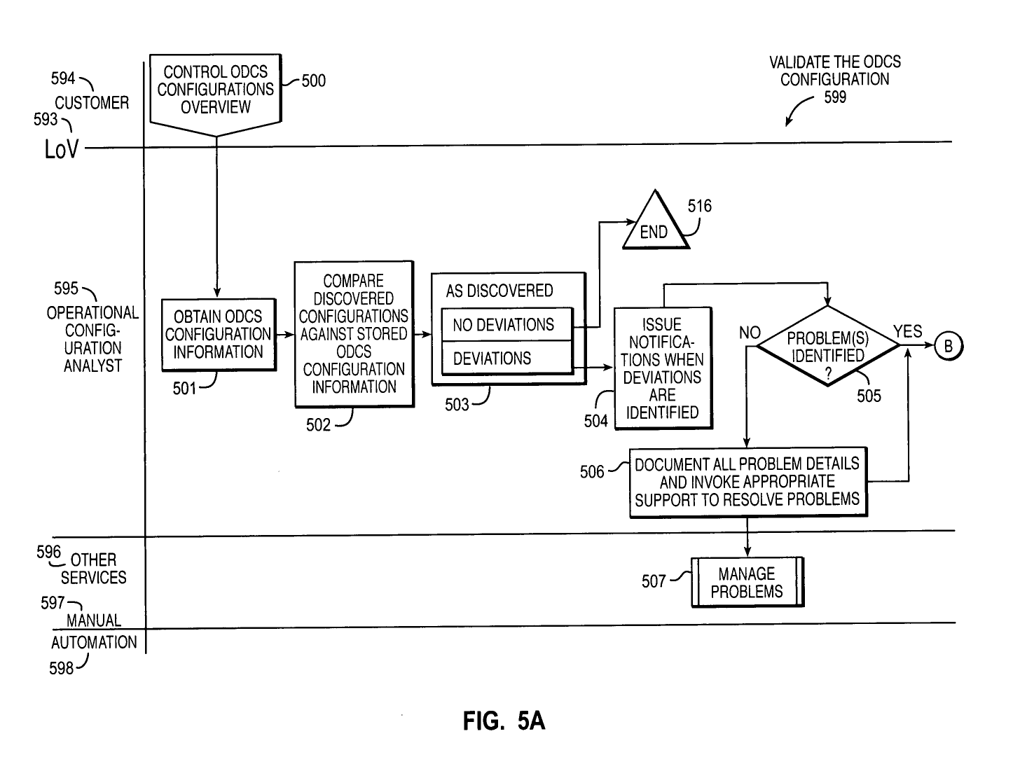

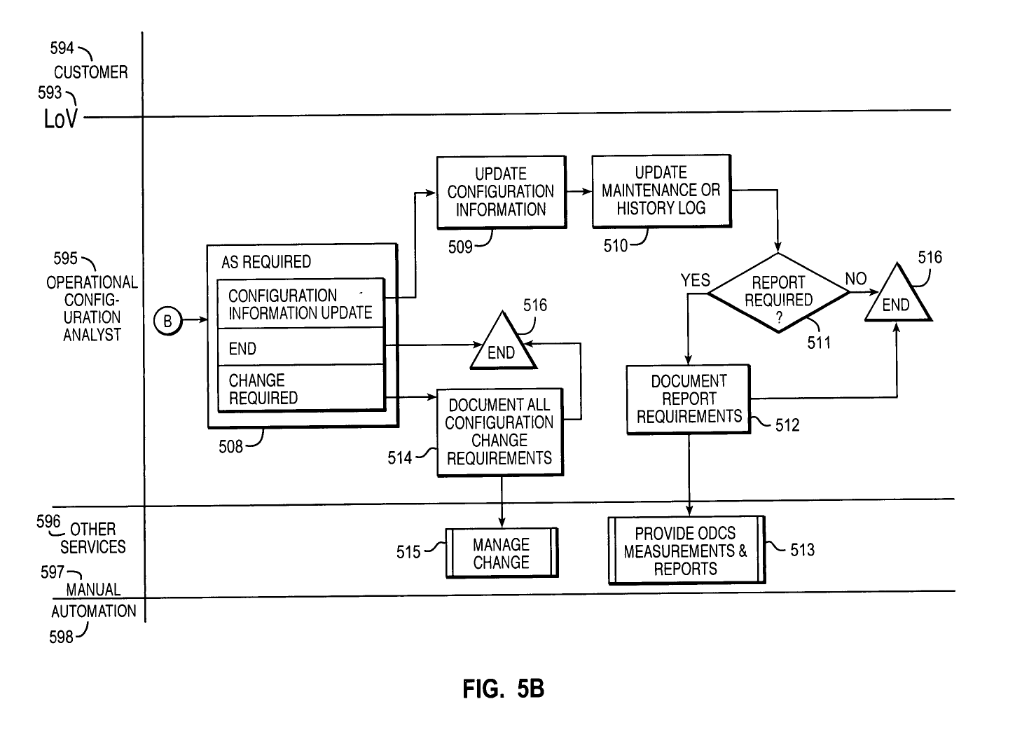

FIGS. 5A and 5B together form a flow chart, illustrating an example of a subprocess to validate configuration information for operational components. Beginning with a general view of FIGS. 5A and 5B, inputs include: Installed Configurations
Configuration Information
   Outputs include: Exception notifications issued as required
Configuration information updated as required
Change request raised as required
Problem record raised as required

Automated tools may be utilized, but are not shown here, such as software products sold under the trademark TIVOLI by IBM. Examples are TIVOLI Asset Manager (TAM, utilized at blocks 502, 509), Tivoli Problem Manager (TPM, utilized at block 506), Tivoli Change Manager (TCM, utilized at blocks 512, 514), and ODCS Delivery Database at block 510.

501: Obtain Configuration Information. Obtain configuration information using queries or extracts.

502: Compare discovered configurations against stored configuration information.

503: Identify any deviations between discovered configurations and stored configurations. If deviations found, proceed to 504, Issue Notifications When Deviations Are Identified. If no deviations found, proceed to end 516.

504: Issue notifications when deviations are identified (especially unexpected deviations), using appropriate mechanisms (e.g., problem notification, exception report, etc.) Decision 505: Problem(s) Identified? Determine if any problems were identified. If Yes, proceed to Document All Problem Details, 506. If No, proceed to 508.

506: Document all problems in detail in preparation for calling the Manage Problems process.

507: Manage Problems (Operational Process). Invoke the Manage Problems operational process to resolve the problem(s).

Multiple choice block 508: Determine if updates are required to stored configuration information. If Yes, proceed to update, 509. Determine if any changes are required. If Yes, proceed to Document All Change Requirements, 514. Or else proceed to end, 516.

514: Document all change requirements in preparation for calling the Manage Change process.

515: Invoke the Manage Change process to handle the changes.

509: Update Configuration Information. Update the stored configuration information based on results from the discovered deviations.

510: Update Maintenance or History Log. Update the scheduled maintenance log documenting the audit results or the requested configuration information update.

Decision 511: Report Required? Determine if a report is needed to reflect the audit results or configuration information updates. If Yes, proceed to Document Report Requirements, 512. If No, Proceed to end, 516.

512: Document Report Requirements. If a report is required to reflect the configuration repository audit or configuration information update activity, document the report requirements.

513: Provide ODCS Measurements and Reports. Invoke the Provide ODCS Measurements and Reports operational process to produce the required report.

516: End. Return to the Control ODCS Configurations Overview in FIG. 4.

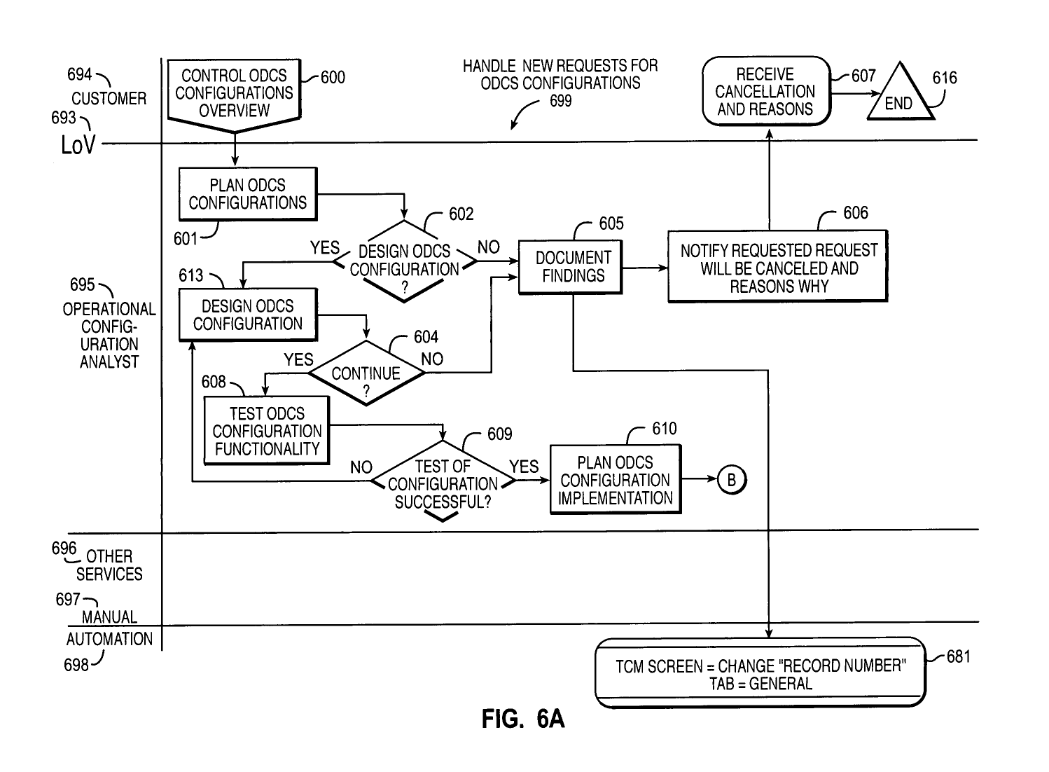

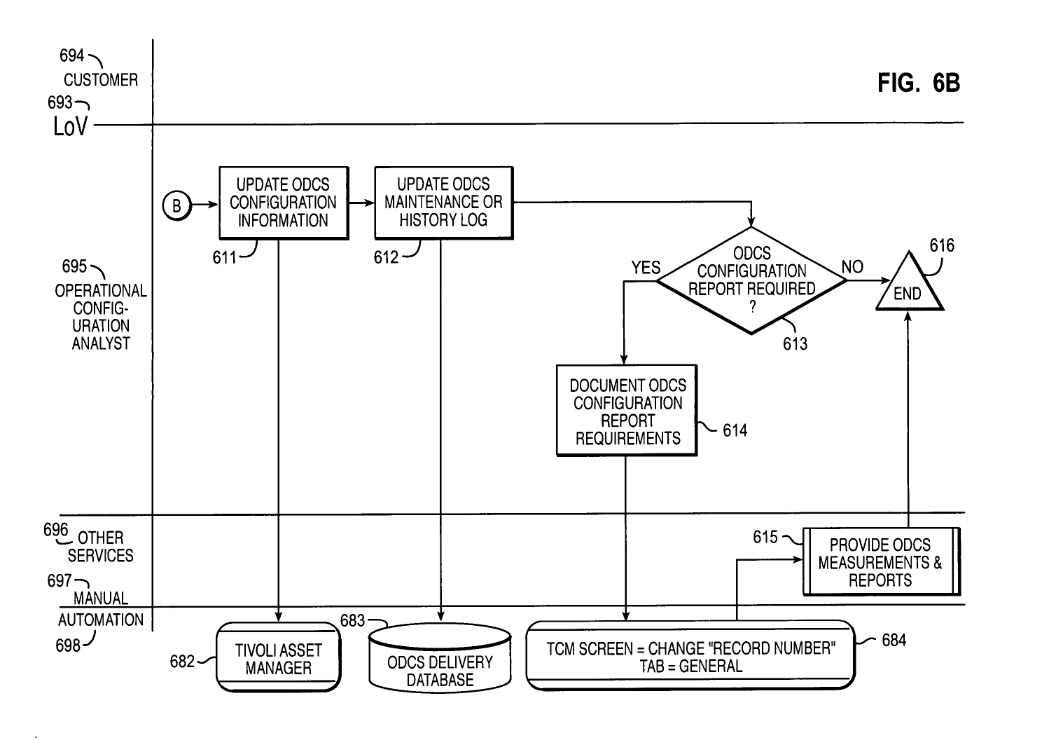

FIGS. 6A and 6B together form a flow chart, illustrating an example of a subprocess, to handle new configuration requests, and to facilitate configuration activities across all platforms. Beginning with a general view, automated tools may be utilized, and are shown here, such as TIVOLI Asset Manager (TAM, 682, utilized at block 611), Tivoli Change Manager (TCM, 681 and 684, utilized at blocks 605 and 614), and ODCS Delivery Database 683, utilized at block 612. These serve as means for maintaining information concerning the shared platform, and means for documenting physical and logical configuration information.

Block 600: this subprocess, to handle new configuration requests, is called by Control ODCS Configurations Overview (FIG. 4).

601: Plan Configuration (Subprocess). Invoke the Plan Configuration subprocess for a request for a new configuration. Consider some examples of planning (block 601) for adequate capacity. The customer, during the course of doing business, may exceed the expected level of resource utilization. Concerning storage: Plan storage configuration, so that each customer may use 25% more than expected, without notice. (E.g. customer is expected to use about 100 GB, but may use up to 125 GB without notice.)
Plan tape storage configuration, so that each customer has its own unique tape in the end.

Concerning processors and memory: Preferably, diversify the kinds of businesses who share the same box. Take advantage of variability in times of day or times of the month when peak utilization occurs. This is preferred over putting customers who are in the same kind of business, whose utilization will peak at the same time, on the same box.

Decision 602: Design? Determine if the request should continue to the design stage. If Yes, proceed to Design Configuration, 613. If No, proceed to Document Findings, 605.

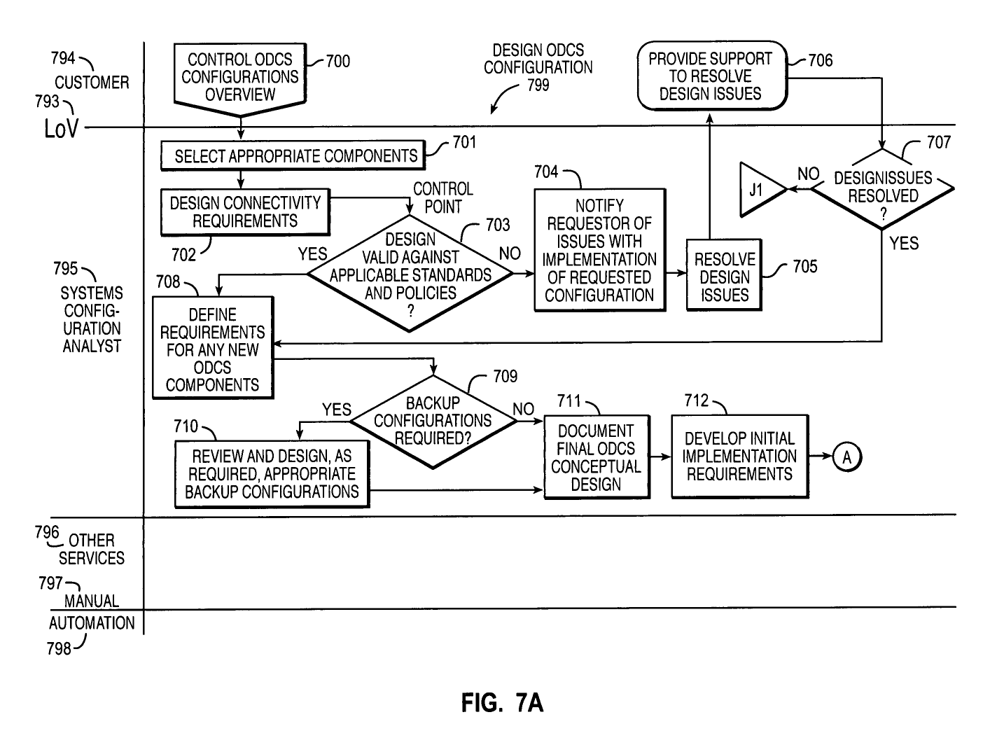

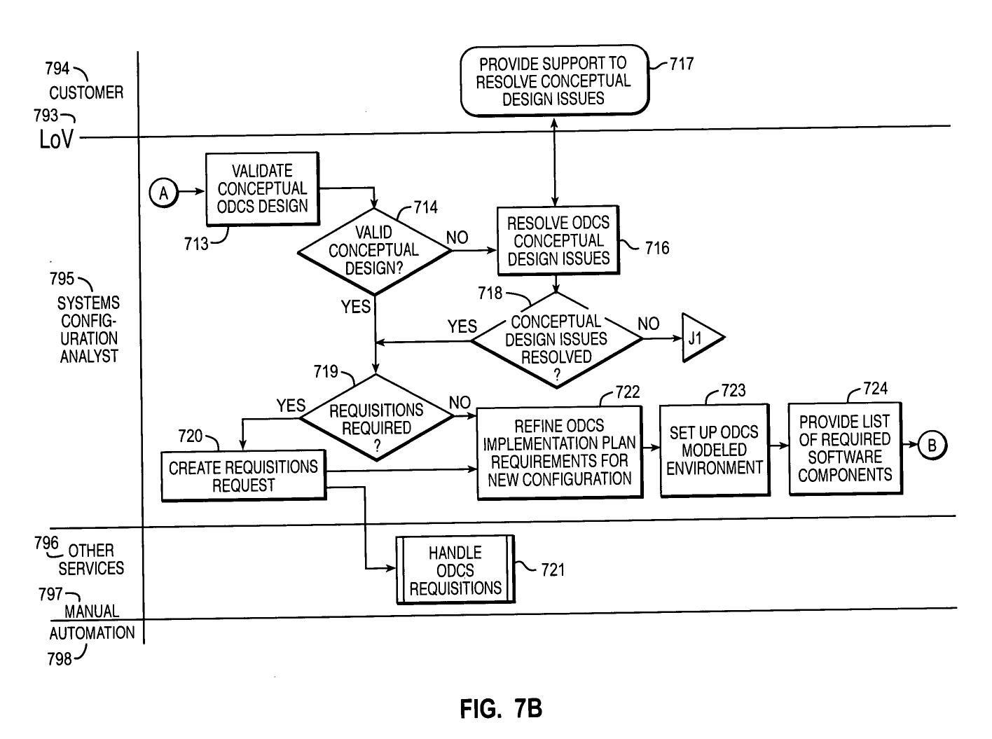

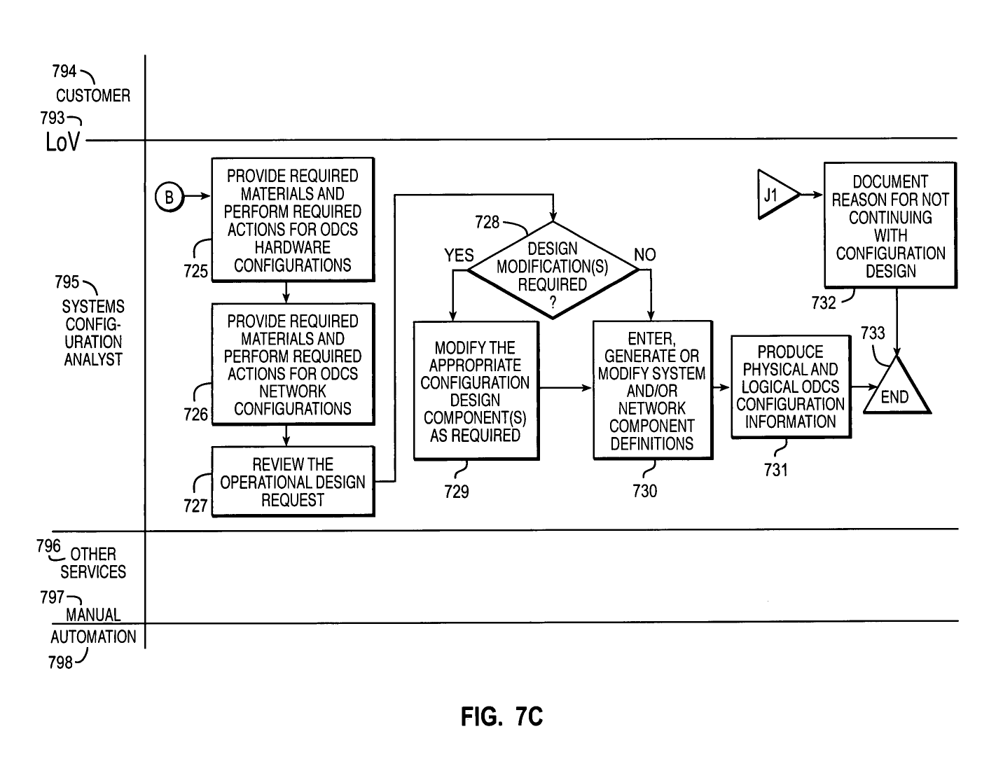

613: Design Configuration (Subprocess). If request processing should continue, invoke the Design Configuration subprocess. See FIGS. 7A, 7B, and 7C.

604: Continue? Determine if the request should continue through the process. If Yes, proceed to Test Configuration, 608. If No, proceed to Document Findings.

605: Document Findings. Document the reasons found during the plan or design phase that necessitate cancelling the configuration request.

606: Notify Requester that Request Will Be Canceled and Reasons Why. If request processing should not continue, document the reason(s) for canceling the request and communicate those reasons to the requester.

607: Receive Cancellation and Reasons. Receive the cancellation notification and reason why the request was cancelled. Proceed to end, 616.

608: Test Configuration (Subprocess). Invoke the Test Configuration subprocess.

609: Testing Successful? Determine if the configuration testing was successful. If Yes, proceed to Plan Configuration Implementation 610. If No, return to Design Configuration 613.

610: Plan Configuration Implementation (Subprocess). If testing was successful, invoke the Plan Configuration Implementation subprocess.

611: Update Configuration Information. Update the configuration information per the request.

612: Update Maintenance or History Log. Update the scheduled maintenance log documenting the requested configuration information update.

613: Report Required? Determine if a report is needed to reflect the configuration information updates. If Yes, proceed to Document Report Requirements. If No, proceed to end, 616.

614: Document Report Requirements. If a report is required to reflect the configuration repository audit or configuration information update activity, document the report requirements.

615: Provide ODCS Measurements and Reports. Invoke the Provide Service Delivery Measurements and Reports operational process to produce the required report. Proceed to end, 616. Return to the Control ODCS Configurations Overview in FIG. 4.

FIGS. 7A, 7B, and 7C together form a flow chart, illustrating an example of a subprocess to design a configuration, i.e. to design hardware, software, and network configurations and validate the proposed configurations. Beginning with a general view, inputs include:
Configuration components
Configuration request
Configuration information.
   Outputs include: requisition requests
Configuration Implementation Plan
Notification to requester
Ongoing support requirement
Change request
Physical and logical configuration information.

Concerning decision 703 (Design Valid?): note this may serve as a configuration management control point. This involves an Information Technology service management corporate instruction regarding configuration design—designing and validating software, hardware, and network configurations in accordance with customer requirements, installation-specific, and/or site constraints.

Automated tools may be utilized, but are not shown here, such as Tivoli Problem Manager (TPM, utilized at block 720), Tivoli Change Manager (TCM, utilized at blocks 711, 724, 727, 731).

Block 700: this subprocess to design a configuration is called by overview in FIG. 4.

701: Select the appropriate components (e.g., model, type, and number of hardware boxes, version and release of software products, required associated facilities, etc.).

702: Design Connectivity Requirements. Design the network topology required- to interconnect the selected components.

Decision 703: Design Valid Against Applicable Standards and Policies? Determine if the conceptual design is valid against applicable configuration standards and policies. If Yes, proceed to Define Requirements for Any New Components, 708. If No, proceed to Notify Requester of Issues with Implementation of Requested Configuration, 704.

704: Notify Requester of Issues with Implementation of Requested Configuration. If the design is not consistent with configuration standards and policies, document all issues with implementation of the requested configuration and notify the requester of all the issues.

705: Resolve Design Issues. Resolve the design issues with the requester.

706: Provide Support to Resolve Design Issues. Assist in resolving any design issues.

707: Design Issues Resolved? Determine if the design issues were resolved. If Yes, return to Define Requirements for Any New Components 708. If No, proceed to Document Reason for Not Continuing 732.

708: Define Requirements for Any New Components. If the design is consistent with configuration standards and policies, define requirements of any new components to be acquired.

709: Backup Configurations Required? Review configurations to determine if backup configurations are required. If Yes, proceed to Review and/or Design Appropriate Backup Configurations 710. If No, proceed to Document Final Conceptual Design 711.

710: Review and/or Design Appropriate Backup Configurations. If backup configurations are required, review and/or design the appropriate backup configurations.

711: Document Final Conceptual Design. Document the final conceptual design of the configuration, including the connectivity of all required components.

712: Develop Initial Implementation Requirements. Develop the initial requirements for implementation of the new configuration.

713 Validate Conceptual Design. Validate the given conceptual design using simulation, or prototyping.

714: Valid Conceptual Design? Determine if the conceptual design is valid. If Yes, proceed to Requisition Required, decision 719. If No, proceed to Resolve Conceptual Design Issues 716.

716: Resolve Conceptual Design Issues. Resolve the conceptual design issues with the requester.

717: Provide Support to Resolve Conceptual Design Issues. Assist in resolving any conceptual design issues.

718: Conceptual Design Issues Resolved? Determine if the conceptual design issues were resolved. If Yes, return to 719. If No, proceed to Document Reason for Not Continuing 732.

719: Requisition Required? Determine if procurement is required to procure needed components for the configuration. If Yes, proceed to Create Requisitions Request 720. If No, proceed to Refine Implementation Plan Requirements for New Configuration 722.

720 Create Requisitions Request. If required, complete the Requisitions Request.

721: Handle ODCS requisition (Operational Process). Invoke the Handle ODCS requisition operational process to procure the required component(s).

722 Refine Implementation Plan Requirements for New Configuration. Refine the implementation plan of the new configuration.

723: Set Up Model Environment. Set up the model environment.

724: Provide List of Required Software Components. Provide list of required software components, and their relationships with the current environment.

725: Provide Required Materials and Perform Required Actions for Hardware Configurations. Provide required materials and perform required actions for hardware configurations as follows:
Provide diagrams and tables representing the physical components and their connections (these will be used to install the corresponding equipment)
Draw and validate the desired machine room layout, and/or rack diagrams
Calculate facilities requirements in terms of space, power, air conditioning, water cooling, etc.)
Derive from the above the required elements (e.g., power outlets, air conditioning sensors, plumbing, etc.)
Determine required security elements (e.g., doors, locks, badge readers, etc.)
Determine cabling requirements; i.e., cable types and lengths.

726: Provide Required Materials and Perform Required Actions for Network Configurations. Provide required materials and perform required actions for network configurations as follows:
Provide network topology diagrams
Analyze circuit capacity
Circuit engineering
Customize network software configuration.

727: Review Configuration Operational Design Request.

728: Design Modification(s) Required? Determine if any design modifications are required.
If Yes, proceed to Modify Configuration Design as Required 729. If No, proceed to Enter, Generate or Modify System and/or Network Component Definitions 730.

729: Modify Configuration Design as Required. Work with the Operational Configuration Analyst to modify the configuration design as required.

730: Enter, Generate or Modify System and/or Network Component Definitions. Enter, generate or modify system and/or network component definitions following the operational design requirements and according to the applicable component definition rules and naming conventions.

731: Produce Physical and Logical Configuration Information. Document the physical and logical configuration information for the components. Proceed to end 733.

732: Document Reason for Not Continuing. Document the reason(s) for not continuing with the request.

733: end. Return to the overview in FIG. 4.

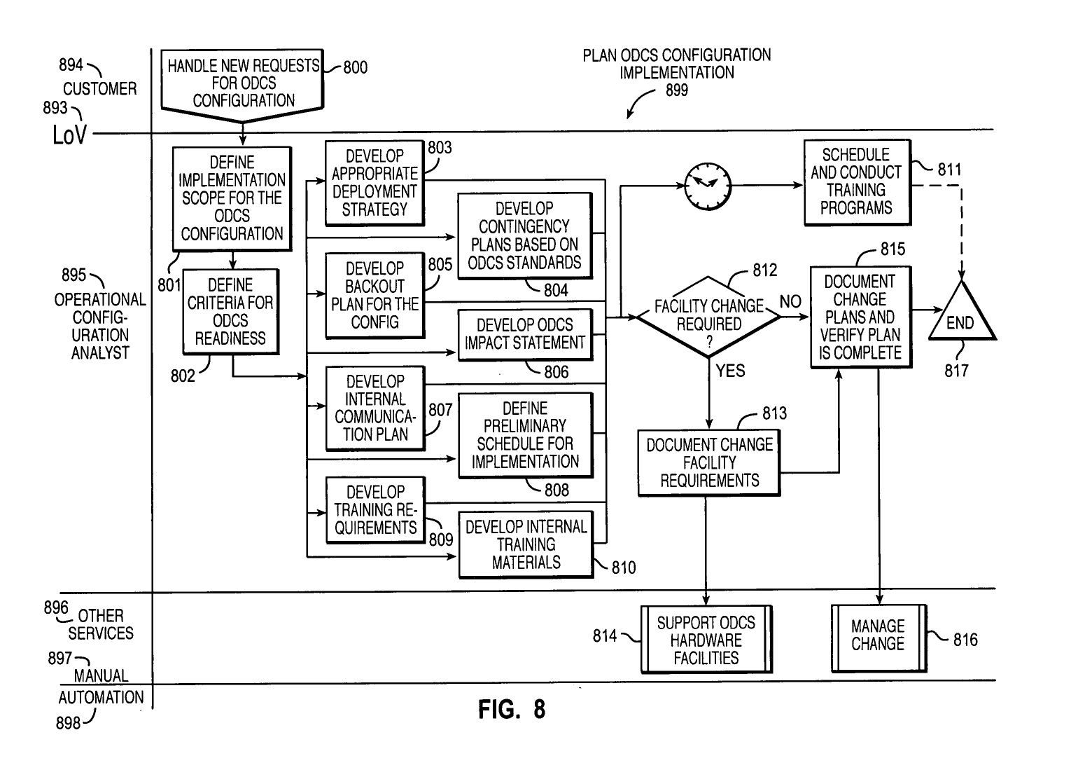

FIG. 8 illustrates an example of a subprocess to plan configuration implementation.
Inputs include: Preliminary Configuration Implementation Plan
Configuration information.
Outputs include: Final Implementation Plan
Change request raised to implement the configuration.

Concerning block 813: note this may serve as a configuration management control point. This involves an Information Technology service management corporate instruction regarding environmental planning—determining the physical specifications required to support a configuration. In addition to physical planning this activity involves the maintenance of an overall IT environment that provides for security and availability of IT services.

800: this subprocess is called by another subprocess, Handle New Configuration Request (see FIGS. 6A and B).

801: Define Implementation Scope. Define the implementation scope for the configuration.

802: Determine Criteria for ODCS Readiness. Determine what ODCS Delivery needs to do to be ready for implementation.

803: Develop Deployment Strategy. Work with all the appropriate parties to develop a deployment strategy.

804: Develop Contingency Plans. Develop and document all contingency plans to ensure successful implementation.

805: Develop Backout Plan. Develop and document a backout plan.

806: Develop Impact Statement. Develop an impact statement.

807: Develop Communication Plan. Develop communication requirements based on the implementation plan.

808: Define a preliminary implementation schedule.

809: Develop Training Requirements. Develop the training requirements (both user and support) for the new configuration.

810: Develop the Training Materials. Develop the required training materials.

811: Schedule and Conduct Training Programs. Conduct all required training programs.

812: Facility Change Needed? Determine if any hardware facility changes are required to accommodate the new configuration. If Yes, proceed to Document Facility Requirements 813. If No, proceed to Document Change Plans 815.

813: Document Facility Requirements. Document the requirements for the facility changes.

814: Support ODCS Hardware Facilities (Operational Process). Invoke the Support ODCS Hardware Facilities operational process.

815: Document Change Plans. Document the requirements for the configuration changes. Verify Plan is Complete. Review the implementation plan and change record to verify all required documentation is complete.

816: Manage Change (Process). Invoke the Manage Change process.

817: End. Return to the Handle New Configuration Request subprocess.

In conclusion, we have shown examples of systems and methods of configuration management and shared computing resources.

One of the possible implementations of the invention is an application, namely a set of instructions (program code) executed by a processor of a computer from a computer-usable medium such as a memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the method.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

We claim:

1. A method of configuration management, said method comprising:
providing a shared platform that is prepared to accept an incoming customer;
for said incoming customer performing (a)-(c) below;
(a) planning a configuration of hardware, software, and network components;
(b) designing said configuration;
(c) utilizing at least one configuration management control point;
accepting said incoming customer, among multiple customers, on said shared platform;
sharing hardware and software, among said multiple customers; and
maintaining information concerning said shared platform.

2. The method of claim 1, further comprising, for said incoming customer:
determining customer computing requirements;
testing; and
implementing said configuration.

3. The method of claim 1, further comprising utilizing a configuration management control point at the design stage.

4. The method of claim 1, wherein said designing further comprises
designing connectivity, networking, software and hardware components;
wherein said incoming customer does not impact another customers capacity requirements.

5. The method of claim 1, wherein said planning further comprises
developing specifications for an environment;
evaluating the hardware and software and how it will be used;
validating the configuration against business requirements; and
estimating effort involved in designing, building and testing said configuration.

6. The method of claim 1, wherein said planning further comprises performing calculations for one or more capacity planning items chosen from:
processors;
channel subsystem;
memory;
storage; and
storage area network.

7. The method of claim 1, further comprising allowing one or more of said multiple customers, during the course of doing business, to exceed the expected level of resource utilization.

8. The method of claim 7, further comprising allowing each customer to use about 20% more resources than expected.

9. The method of claim 7, further comprising allowing each customer to use about 25% more resources than expected.

10. The method of claim 1, further comprising providing each of said multiple customers with a tape containing unique stored data belonging to that customer.

11. The method of claim 1, further comprising diversifying said multiple customers, based on kinds of business.

12. The method of claim 1, further comprising capping processor utilization by using a CPU governor.

13. The method of claim 1, further comprising allocating VM minidisks to specific z/LINUX instances.

14. The method of claim 1, further comprising allocating logical processors to said multiple customers.

15. The method of claim 1, further comprising varying the number of parallel access volumes due to a load on said shared platform.

16. A system of shared computing resources, said system comprising:
means for sharing hardware and software, among multiple customers; and
means for accepting an incoming customer;
wherein said incoming customer does not impact another customer's capacity requirements; and
wherein said means for sharing further comprises means for allowing one or more of said multiple customers, during the course of doing business, to exceed the expected level of resource utilization.

17. The system of claim 16, wherein said means for sharing further comprises means for allowing each customer to use about 20% more resources than expected.

18. The system of claim 16, wherein said means for sharing further comprises means for allowing each customer to use about 25% more resources than expected.

19. The system of claim 16, further comprising means for maintaining information concerning said shared platform.

20. The system of claim 16, wherein said means for sharing further comprises means for sharing one or more resources chosen from:
processors;
channel subsystem;
memory;
storage; and
storage area network.

21. The system of claim 16, further comprising means for providing each of said multiple customers with a tape containing unique stored data belonging to that customer.

22. The system of claim 16, further comprising means for capping processor utilization by using a CPU governor.

23. The system of claim 16, further comprising means for allocating VM minidisks to specific z/LINUX instances.

24. The system of claim 16, further comprising means for allocating logical processors to said multiple customers.

25. The system of claim 16, further comprising means for varying the number of parallel access volumes due to load on said platform.

26. A computer-usable medium having computer-executable instructions for configuration management, said computer-usable medium comprising:
means for maintaining information concerning a shared platform that is prepared to accept an incoming customer;
means for performing (a)-(c) below, concerning said incoming customer;
(a) planning a configuration of hardware, software, and network components;
(b) designing said configuration; and
(c) utilizing at least one configuration management control point.

27. The computer-usable medium of claim 26, further comprising means for documenting physical and logical configuration information.

28. The computer-usable medium of claim 26, further comprising means for updating a maintenance log.

29. The computer-usable medium of claim 26, further comprising means for updating configuration information.
